(19) United States
(12) Patent Application Publication
(10) Pub. No.: US 2023/0189852 A1
(43) Pub. Date: Jun. 22, 2023

(54) NUT AND NON-DAIRY COMPONENTS HAVING REDUCED TRACE ELEMENT CONTENT, COMPOSITIONS COMPRISING THEM AND PROCESSES FOR THEIR PRODUCTION

(71) Applicant: ELSE NUTRITION GH LTD, Tel Aviv (IL)

(72) Inventors: Uriel KESLER, Tel Aviv (IL); Hamutal YITZHAK, Tel Aviv (IL); Michael AZAR, Beit Yitzhak (IL); Asher WIDBERG, Haifa (IL); Fabiana BAR-YOSEPH, Haifa (IL)

(73) Assignee: ELSE NUTRITION GH LTD, Tel Aviv (IL)

(21) Appl. No.: 17/926,595

(22) PCT Filed: May 23, 2021
(86) PCT No.: PCT/IL2021/050596

§ 371 Date: Nov. 20, 2022

Related U.S. Application Data
(60) Provisional application No. 63/027,989, filed on May 21, 2020.

(51) Int. Cl. A23L 5/20; A23L 5/30

(52) U.S. Cl. CPC A23L 5/23; A23L 5/273; A23L 5/30

(57) ABSTRACT

The invention provides non-dairy, plant-based components, having reduced trace element contents, food products and nutritional compositions comprising them and methods for their preparation.

### BACKGROUND OF THE INVENTION

Tree nuts, such as almonds, hazelnuts, cashew nuts, Brazil nuts, macadamias, walnuts, and pistachios, are nutrient-dense foods each with a unique composition. In general, these foods contain healthy monounsaturated (MUFA) and polyunsaturated (PUFA) fatty acid profiles; protein; soluble and insoluble fibers; vitamins E and K; folate; thiamine; minerals such as magnesium, manganese, copper, potassium, and selenium; and substances such as zanthophyll carotenoids, antioxidants, and phytosterols compounds, with recognized benefits to human health.

Grains are seeds from plants of the Gramineae family (such as wheat, corn, rice, barley, oat and rye) that have been the basis for human nutrition for thousands of years. Grains are fundamental for sustenance, both for their nutritional value and for their chemical properties that allow for a variety of uses in the food industry. Ancient grains (khorasan wheat, barley, spelt, rye, millet, oat and sorghum) and pseudo cereals (i.e. quinoa, amaranth and buckwheat) are considered healthy due to their higher content of certain components and to their common use as whole grains (see Bordoni et al., International Journal of Food Sciences and Nutrition 2017). Whole grains contain higher amounts of positive components compared to refined grains. Most importantly, dietary fiber, vitamins and minerals, but also other bioactive molecules such as omega 3 fatty acids, prebiotic oligosaccharides, phytosterols, polyphenols, etc., and probably the interaction of all the components rather than each individual one gives whole grains their nutritional value (Slavin et al. 2001).

While usually nuts and grains are recommended as good source of nutrients with health benefits, their relatively high levels of trace elements could be too high and to some extent even toxic.

The most vulnerable population to the harmful effects of trace elements in food include infants and children, the elderly, and consumers who may have chronic health conditions.

At high levels, some trace elements, i.e., heavy metals, such as arsenic, lead, cadmium, mercury and others, when found in food products, can be toxic. Eliminating these heavy trace elements entirely from food supply is not always possible because these trace elements are found in the air, water and soil and then taken up by plants as they grow. The FDA and other health and regulatory authorities, therefore, seeks to limit consumer exposure to heavy trace elements to the greatest extent feasible.

For example, the main organs affected by mercury are the brain and the kidneys. Exposure of childbearing-aged women is of particular concern because of the potential adverse neurologic effects of Hg in fetuses. Soil may contain lead naturally, or from man-made uses of lead such as paint (near older homes), gasoline (near roadways), mining, manufacturing, and disposal. High levels of lead exposure can seriously harm children's health and development, specifically the brain and nervous system. Neurological effects from high levels of lead exposure during early childhood include learning disabilities, behavior difficulties, and lowered IQ. Because lead can accumulate in the body, even low-level chronic exposure can be hazardous over time. In general, leafy vegetables such as lettuce and spinach, potatoes and grains, peanuts, soybeans, and sunflower seeds contain high levels of cadmium due to bioaccumulation from the soil. Generally, the critical organ for Cd is the kidney and kidney dysfunction is one of the most characteristic signs of exposure to Cd. Ingestion of high amounts of Cd may lead to a rapid onset with severe nausea, vomiting, and abdominal pain. Inorganic arsenic exposure in utero and in the very young is associated with impaired intellectual development, such as decreased performance on certain developmental tests that measure learning.

Manganese (Mn) is a trace element essential to humans and is associated with the formation of connective and bony tissue, growth and reproductive functions and with carbohydrate and lipid metabolism. Manganese is also a known neurotoxin, but little information exists about levels of manganese that cause toxicity. Symptoms of manganese toxicity are similar to Parkinson's Disease and can also include disorientation, memory impairment, anxiety and compulsive behavior. Food is the most important source of manganese exposure for the general population. The concentrations in foodstuffs vary considerably but are mostly below 5 mg/kg. Grain, rice, and nuts, however, may have manganese levels exceeding 10 mg/kg or even 30 mg/kg in some cases.

Magnesium is an essential mineral. It is a cofactor in more than 300 enzyme systems that regulate diverse biochemical reactions in the body, including protein synthesis, muscle and nerve function, blood glucose control, and blood pressure regulation. Magnesium is required for energy production, oxidative phosphorylation, and glycolysis. It contributes to the structural development of bone and is required for the synthesis of DNA, RNA, and the antioxidant glutathione. Magnesium also plays a role in the active transport of calcium and potassium ions across cell membranes, a process that is important to nerve impulse conduction, muscle contraction, and normal heart rhythm. However, having too much magnesium in the blood can be dangerous. The medical term for this is hyper-magnesemia, and a magnesium overdose is one possible cause. If the body has absorbed too much magnesium, a person may notice lethargy, facial flushing, diarrhea, nausea, stomach cramps, vomiting, depression, muscle weakness, an irregular heartbeat, low blood pressure, urine retention, breathing difficulties and even cardiac arrest.

Scientific, medical and regulatory authorities such as the European Society of Pediatric Gastroenterology, Hepatology and Nutrition (ESPGHAN), Codex Allimentarius, European Food Safety Authority (EFSA), etc. set minimum and maximum levels for nutrients based on their requirement for age group and their safety and tolerability. For some nutrients, mainly micronutrients such as vitamins and minerals there is insufficient information for a science-based risk assessment, and only a guidance upper levels (GUL) are set based on the maximum level of total chronic daily intake of a nutrient (from all sources) judged to be unlikely to pose a risk of adverse health effects to humans. Therefore, where necessary, and to the extent possible, ULs are derived for each separate life-stage group, e.g. infants, children, adults, elderly, and women during pregnancy or lactation. The purpose of the GULs is to provide guidance to manufacturers and they should not be interpreted as goal values. ULs may be derived for various life stage groups in the population and is an estimate of the highest level of intake which carries no appreciable risk of adverse health effects. Those levels are especially relevant for the vulnerable populations of infant and young children or subjects with compromised metabolism.

Infant formula is one of the most regulated food. The nutritional safety and adequacy of infant formula shall be scientifically demonstrated to support growth and development of infants. The recommended range for different nutrients ensures proper supply of nutrients for the infant needs. These levels are values derived on the basis of meeting nutritional requirements of infants and an established history of apparent safe use. The inclusion of unnecessary components, or unnecessary amounts of components, may put a burden on metabolic and other physiologic functions of the infant.

There is therefore a true need for processes and products that comprise nuts, grains or any type of plant-based food component with controlled trace elements content, such as for example plant-based non-dairy formula for infants, that can provide all essential nutritional needs similar to the gold standard of breast milk nutritional profile without the disadvantages of relatively high levels of trace elements currently known non-dairy formula.

### SUMMARY OF THE INVENTION

Thus, the present invention provides a plant-based food component or ingredient having trace element content that is reduced than, as compared with, said trace element content in the corresponding natural occurring (in any form) plant-based food component or ingredient. A plant-based food component or ingredient of the invention contains reduced levels of at least one trace element as compared with said trace element content in the corresponding natural occurring (in any form) plant-based food component or ingredient.

When referring to “a plant-based food component or ingredient” it should be understood to encompass any type of food component originating from, extracted from, based on, prepared from, a plant naturally occurring in nature, either non-processed or processed (pealed, roasted, rolled, cooked, boiled, hydrolyzed, and so forth and any combination thereof) and in any form (grinded, shredded, powdered, floured, chopped, mashed, non-treated and any combination thereof).

In some embodiments said plant-based component is selected from grain, pseudo-grain, pulses, legumes, oilseeds, cereals, fruit, vegetables, nuts and any combinations thereof.

In some embodiments said plant-based component is a legume. In some embodiments said legume is selected from alfalfa, clover, beans, peas, chickpeas, lentils, lupins, mesquite, carob, soybeans, peanuts, and tamarind and any combinations thereof.

In some embodiments said plant-based component is a grain. In some embodiments, said grain is selected from finger millet, fonio, maize (corn), millet, barley, rye grains, rice, oats, rye, teff, wheat, wild rice, and any combinations thereof.

In some embodiments, said plant-based component is a pseudo-cereal grain. In some embodiments said pseudo-cereal grain is selected from buckwheat, amaranth, chia, quinoa and any combinations thereof.

In some embodiments, said plant-based component is a pulse. In some embodiments, said pulse is selected from lentil, pea, chickpeas, common beans, common peas (garden peas), fava beans, lentils, lima beans, lupins, mung beans, soybeans and any combinations thereof.

In some embodiments, said grain is selected from grains and/or pseudo grains such as but not limited to buckwheat, barley, rice, maize, corn, millet, oats, rye, pea, chickpea, lentils, quinoa, teff, chia, bean, fava bean, sunflower, safflower, flax, rapeseed, wheat, sorghum, millet, oats, triticale, fonio, mung bean, pumpkin, amaranth and any combinations thereof.

In other embodiments, said at least one type of grain is buckwheat. In further embodiments, at least one type of grain is a whole grain.

In some embodiments, said at least one type of grain is in any type of form (peeled from seedcoat, unpeeled, grounded, blanched, powdered, floured, milled and so forth). In some embodiments said grain component of the invention is further treated by at least one of peeling, steaming, heating, grinding, hydrolyzing, blanching, roasting and so forth. In some embodiments pre-treatment of a grain component of the invention is performed either before, during or after lowering of the level of trace element in said grain.

In some further embodiments said grain and/or pseudo-grain are treated for reducing/adjusting levels of fibers (as compared with fiber levels in the raw natural form of said grain and/or pseudo-grain). For example, fiber levels are reduced/adjusted to be suitable for the intended population of subjects to be treated/administered with said grain (i.e. infants, toddlers, adolescent, elderly, subjects with jeopardized digestion system suffering from ailments such as allergies, colitis, inflammatory bowel disease, irritable bowel disease, Crohn's disease, and any combinations or conditions associated therewith). In some further embodiments said reduction or adjustment of fibers can be performed by eliminating the fibers from the composition and/or by their cleavage to other carbohydrates.

In some embodiments, reduction or adjustment of fiber of said grain and/or pseudo-grain component of the invention is performed either before, during or after lowering of the level of trace element in said grain and/or pseudo-grain.

In other embodiments said grain and/or pseudo-grain is pre-hydrolyzed. This hydrolyzation is performed for the purpose of hydrolyzing the carbohydrates of said grain and/or pseudo-grain (such as for example buckwheat), thus reducing its viscosity. In some embodiments, said hydrolyzation is performed by use of an acid or an enzyme (for example amylase).

In some embodiments, said plant-based component is a nut. In some embodiments a nut component or ingredient is selected from, but not limited to, almond, brazil nut, candlenut, cashew, chestnut, filbert, hazelnut, Chilean hazelnut, hickory nut, macadamia nut, pecan, Malabar chestnut, mongongo, peanut, pine nut, pistachio, walnut yeheb nut and any combination thereof.

In some embodiments said nut is an almond. When referring to almond, it should be understood to encompass any type of almond tree shelled drupe (Prunus dulcis, syn. Prunus amygdalus Batsch., Amygdalus communis L., Amygdalus dulcis Mill), in any type of form (peeled from seedcoat, unpeeled, grounded, blanched, powdered, floured, milled and so forth).

In some embodiments said nut is further pre-treated to lower the levels (amount) of phytic acid in said nut. In some embodiments said pre-treatment of the nut is performed by at least one of the following: treatment of said nut component with phytase enzyme, soaking of said nut component in water, heating of nut component, pealing of nut, steaming of said nut, blanching and roasting and any combinations thereof.

In some embodiments, said reduction or lowering of phytic acid levels is for the removal of substantially all phytic acid from the nut component of a composition of the invention (i.e. said nut comprising no more than 0.001-0.5% wt of phytic acid).

In some embodiments said nut is further treated by at least one of peeling, steaming, heating, grinding, hydrolyzing, blanching, roasting and so forth. In some embodiments pre-treatment of a nut component of the invention is performed either before, during or after lowering of the level of trace element in said nut.

In some embodiments, said plant-based component is an oilseed. In some embodiments said oilseed is selected from rapeseed, black mustard, rapeseed (including canola), sunflower seeds, safflower, flax seed, hemp seed and any combinations thereof.

When referring to “a grain component or ingredient” it should be understood to encompass any type of single grain or pseudo-grain or seed naturally occurring in nature, either non-processed or processed (pealed, roasted, cooked, boiled, hydrolyzed, and so forth and any combination thereof) and in any form (grinded, shredded, powdered, chopped, mashed, non-treated and any combination thereof).

When referring to “reduced trace element content than its content in the corresponding natural occurring nut and/or plant-based component and/or grain’” it should be understood to encompass a level or content of trace element in said nut or plant-based component, grain or seed that is lower than that of its level in its raw form as found in nature (for reference database https://fdc.nal.usda.gov/index.html).

| | Almond | | Almond | | | | Buckwheat | |
|---|---|---|---|---|---|---|---|---|
| Trace | (roasted nut) | | (milk) | | Buckwheat | | (flour) | |
| Element | 100 g | | 100 gr | | 100 gr | | 100 gr | |
| Mg | 258 | mg | 6.8 | mg | 231 | mg | 251 | mg |
| Cu | 0.87 | mg | 0.021 | mg | 1.1 | mg | 0.515 | mg |
| Mn | 2.02 | mg | 0.045 | mg | 1.3 | mg | 2.03 | mg |

In some embodiments said reduction is by at least 20% of the level in natural occurring nut and/or plant-based component and/or grain or seed. In some embodiments said reduction is by at least 30% of the level in natural occurring nut and/or plant-based component and/or grain. In some embodiments said reduction is by at least 40% of the level in natural occurring nut and/or plant-based component and/or grain. In some embodiments said reduction is by at least 50% of the level in natural occurring nut and/or plant-based component and/or grain. In other embodiments said reduction is by at least 60% of the level in natural occurring nut and/or plant-based component and/or grain. In further embodiments said reduction is by at least 70% of the level in natural occurring nut and/or plant-based component and/or grain. In other embodiments said reduction is by at least 80% of the level in natural occurring nut and/or plant-based component and/or grain. In some other embodiments said reduction is by at least 90% of the level in natural occurring nut and/or plant-based component and/or grain.

In some embodiments said trace element is selected from Manganese (Mn) and/or Magnesium (Mg). In other embodiments, said trace element is selected from Arsenic (As), Cadmium (Cd), Lead (Pb), Mercury (Hg), Copper (Cu), Aluminum (Al), Manganese (Mn), Magnesium (Mg) and any combinations thereof.

In some embodiments, said nut and/or plant-based component and/or grain components or ingredients of the invention have Manganese (Mn) content between 0 to 20 ppm. In some embodiments, said nut and/or plant-based component and/or grain components or ingredients of the invention have Manganese (Mn) content between 0 to 10 ppm. In some embodiments, said nut and/or plant-based component and/or grain components or ingredients of the invention have Manganese (Mn) content of 1, 2, 3, 4, 5, 6, 7, 8, 9, 10, 15 or 20 ppm. In some embodiments, said nut and/or plant-based component and/or grain components or ingredients of the invention have Manganese (Mn) content between 0 to 8 ppm. In some embodiments, said nut and/or plant-based component and/or grain components or ingredients of the invention have Manganese (Mn) content of 1, 2, 3, 4, 5, 6, 7, or 8 ppm. In some embodiments, said nut and/or plant-based component and/or grain components or ingredients of the invention have Manganese (Mn) content between 0 to 5 ppm. In some embodiments, said nut and/or plant-based component and/or grain components or ingredients of the invention have Manganese (Mn) content between 0 to 3 ppm. In some embodiments, said nut and/or plant-based component and/or grain components or ingredients of the invention have Manganese (Mn) content of 1, 2, 3, 4, or 5 ppm.

In some embodiments, said nut and/or plant-based component and/or grain components or ingredients of the invention have Magnesium (Mg) content is between 0 to 1500 ppm. In some embodiments, said nut and/or plant-based component and/or grain components or ingredients of the invention have Magnesium (Mg) content of 0, 10, 20, 30, 40, 50, 60, 70, 80, 90, 100, 200, 300, 400, 500, 600, 700, 800, 900, 1000, 1100, 1200, 1300, 1400 or 1500 ppm. In some embodiments, said nut and/or plant-based component and/or grain components or ingredient of the invention have Magnesium (Mg) content is between 0 to 1200 ppm. In some embodiments, said nut and/or plant-based component and/or grain components or ingredients of the invention have Magnesium (Mg) content of 0, 10, 20, 30, 40, 50, 60, 70, 80, 90, 100, 200, 300, 400, 500, 600, 700, 800, 900, 1000, 1100 or 1200 ppm. In some embodiments, said nut and/or plant-based component and/or grain components of the invention have Magnesium (Mg) content of between 0 to 1000 ppm. In some embodiments, said nut and/or plant-based component and/or grain components have Magnesium (Mg) content of between 0 to 500 ppm. In some embodiments, said nut or grain components or ingredients of the invention have Magnesium (Mg) content of 0, 10, 20, 30, 40, 50, 60, 70, 80, 90, 100, 200, 300, 400, 500, 600, 700, 800, 900 or 1000 ppm.

In some embodiments, said grain is buckwheat and wherein Manganese (Mn) content is between 0 to 20 ppm. In some embodiments, said grain is buckwheat and wherein Manganese (Mn) content is between 0 to 10 ppm. In other embodiments, said grain is corn and wherein Manganese (Mn) content is between 0 to 5 ppm.

In some embodiments, a nut and/or plant-based component and/or grain components of the invention has Arsenic (As) content of between 0 to 1 ppm.

In some embodiments nut and/or plant-based component and/or grain components have Arsenic (As) contents of 0.5 ppm, 0.025 ppm, 0.02 ppm, 0.01 ppm, or <0.01 ppm.

In some embodiments, a nut and/or plant-based component and/or grain components of the invention has Cadmium (Cd) content of between 0 to 0.05 ppm.

In some embodiments said nut and/or plant-based component and/or grain components of the invention have Cadmium (Cd) content of 0.04 ppm, 0.03 ppm, 0.02 ppm, 0.01 ppm, or <0.01 ppm.

In some embodiments, a nut and/or plant-based component and/or grain components of the invention has Lead (Pb) content of between 0 to 0.05 ppm.

In some embodiments, a nut and/or plant-based component and/or grain components of the invention has Lead (Pb) content of 0.04 ppm, 0.03 ppm, 0.02 ppm, 0.01 ppm, or <0.01 ppm.

In some embodiments, a nut and/or plant-based component and/or grain components of the invention have Mercury (Hg) content of between 0 to 1 ppm.

In some embodiments, a nut and/or plant-based component and/or grain components of the invention has Mercury (Hg) content of 0.5 ppm, 0.1 ppm, 0.05 ppm, 0.01 ppm, or <0.01 ppm.

In some embodiments, a nut and/or plant-based component and/or grain components of the invention have a content of Copper (Cu) is between 0 to 1 ppm.

In some embodiments, a nut and/or plant-based component and/or grain components of the invention has Copper (Cu) content of 0.5 ppm, 0.1 ppm, 0.05 ppm, 0.01 ppm, or <0.01 ppm.

In some embodiments said nut and/or plant-based component and/or grain component has a protein to Mg ratio of at least 100. In further embodiments, said nut and/or plant-based component and/or grain component has a protein to Mg ratio of at least 100, 200, 300, 400, 500, 600, 700, 800, 900 or 1000.

In some embodiments said nut and/or plant-based component and/or grain component has a protein to Mn ratio of at least 15,000. In further embodiments, said nut and/or plant-based component and/or grain component has a protein to Mn ratio of at least 15,000, 16,000, 17,000, 18,000, 19,000, 20,000, 21,000, 22,000, 23,000, 24,000, 25,000, 26,000, 27,000, 28,000, 29,000, or 30,000.

The invention further provides a composition comprising at least one plant-based component having reduced trace element content, as disclosed herein above and below. The invention further provides a composition comprising at least one nut having reduced trace element content, as disclosed herein above and below. The invention further provides a composition comprising at least one grain having reduced trace element content, as disclosed herein above and below.

When referring to a “composition” it should be understood to encompass any type of food or drink composition, cooked, precooked or uncooked compositions. Compositions of the invention may be in the form of powder (to be hydrated with any type of liquid such as cold or warm water, nutritious liquid, etc.), liquid, semi-solid, custard, shake or a ready-to-feed composition in any form. In some embodiments compositions of the invention may be solid or semi-solid food compositions or liquid food compositions. In some embodiments a composition of the invention is a non-dairy composition (i.e. said composition excludes dairy products from its ingredients). In some embodiments a composition of the invention is a dairy composition. In some embodiments a composition of the invention is a non-soy composition (i.e. said composition excludes soy from its ingredients). In some embodiments said composition is selected from an infant formula, a toddler formula, a toddler drink, a kid formula, a kid's drink, a kids shake, an adult formula, an adult drink, an adult shake, a nutritional/food supplement, baby food, cereal based food, supplemental food composition, dietary supplement, nutritional drink, nutritional shake, other type of food, complementary nutrition, meal replacement, complete nutrition, whole balanced nutrition and any combinations thereof.

In some embodiments said composition is an infant formula. In some embodiments said composition is a toddler formula. In some embodiments said composition is a nutritional food supplement. In some embodiments said composition is baby food. In some embodiments said composition is cereal based food. In some embodiments said composition is a complementary nutritional composition. In some embodiments said composition is a functional food formula. In some embodiments said composition is a toddler nutritional drink. In some embodiments said composition is a complete nutritional composition. In some embodiments said composition is a whole balance nutritional composition. In some embodiments said composition is an adult formula. In some embodiments said composition is a nutritional drink.

In a further aspect the invention provides a composition for use in an infant formula. In a further aspect the invention provides a composition for use in a toddler formula. In a further aspect the invention provides a composition for use in a complementary nutrition. In a further aspect the invention provides a composition for use in supplementing the nutrition of a subject. In a further aspect the invention provides a composition for use in a baby food. In a further aspect the invention provides a composition for use in a functional food formula. In a further aspect the invention provides a composition for use in a toddler nutritional drink. In a further aspect the invention provides a composition for use in a complete nutrition. The invention further provides a composition for use in whole balance nutrition of a subject. The invention further provides a composition for use in adult formula. The invention further provides a composition for use in a nutritional drink.

When referring to an “infant” it should be understood to encompass a newborn neonate between the ages of 0-1 years old. This term includes both full term and premature neonates born at any birth weight.

When referring to a “toddler” it should be understood to encompass a human subject between the ages of 1 and 3 years. This term includes humans in this age range at any cognitive or health condition.

When referring to “supplementation of the nutrition of a subject” it should be understood to encompass qualitative and quantitative complementation of the nutrition of a subject (whether a human infant, toddler, child, adolescent, adult, elderly person at any health or physical condition) by recommended nutrients.

When referring to “baby food” it should be understood to encompass any type of food (solid, semi-solid, finger food, bar, snack, etc.) or drink (liquid, semi-liquid, shake, etc.) for infants, toddlers, and children from birth to 5 years old.

When referring to “a nutritional supplement” or “a food supplement” or “a functional food formula” or “a nutritional formula” or “a nutritional supplement” or “a complete nutrition” or “a complementary nutrition” it should be understood to encompass any type of food (solid, semi-solid, finger food, bar, snack, etc.) or drink (liquid, semi-liquid, shake, etc.) for infants, toddlers, children, adults, elderly at any health or physical condition. Additionally, a nutritional or functional food or complementary nutrition or complete nutrition may serve to supplement the nutrition of a healthy subject. Additionally, a nutritional or functional food or complementary nutrition or complete nutrition may serve to supplement the nutrition of a subject recovering from a condition or disease in need of supplemental nutrients since their condition does not allow said subject to receive all dietary required for recovery, or of a healthy subject that participates in exercise and training of any kind. A nutritional or functional food or complete nutrition may serve to prevent/treat/ameliorate/reduce at least one disease or a symptom thereof (such as for example bowel diseases (irritable bowel disease, inflammatory bowel disease, Chron's disease, colitis and any combination or conditions or symptoms thereof), gastrointestinal disorders, malnutrition diseases, inflammatory diseases, irritable bowel disease, cognitive and neurological diseases, cardiovascular diseases and so forth).

A nutritional or functional food or complementary nutrition or complete nutrition may serve as additional supplemental food for subjects that are more vulnerable to malnutrition, nutrient absorption impairment, subjects having lean body mass and declining basal metabolic rate, such as for example elderly subjects (age 65 and above).

When referring to “complete nutrition” or “whole balanced nutrition of a subject” it should be understood to encompass the necessary essential ingredients needed by a subject (whether a human infant, toddler, child, adolescent, adult, elderly person at any health or physical condition) to sustain health and function as recommended by different medical and scientific bodies (for example, ESPGHAN, Codex, EFSA, WHO, FAO, etc).

The invention further provides a method of preparing at least one plant-based component having reduced trace element content as disclosed herein above and below comprising the steps of: (a) providing at least one plant-based ingredient; (b) exposing said at least one plant-based ingredient to at least one of, but not limited to (i) electrodialysis of said trace element content of said at least one plant-based ingredient; (ii) water extraction of said trace element content of said at least one plant-based ingredient; (iii) IOX-exchange resins; (iv) chelating said trace element content with at least one trace element chelating agent and filtering the formed chelate; (v) membrane filtration (vi) air classification; thereby forming said at least one plant-based component having reduced trace element content. In some embodiments, a method of preparing at least one plant-based component having reduced trace element content as disclosed herein above and below comprising the steps of: (a) providing at least one plant-based ingredient; (b) reacting said at least one plant-based ingredient to at least one trace element chelating agent thereby forming a chelate of said trace element content; (c) filtering said chelate of said trace element content from said at least one plant-based ingredient; thereby forming said at least one plant-based component having reduced trace element content. In some embodiments said at least one chelating agent is citric acid.

When referring to “electrodialysis” it should be understood to refer to a process of transport of trace element salt ions from one solution through ion-exchange membranes to another solution under the influence of an applied electric potential difference. This is done in a configuration called an electrodialysis cell. The cell consists of a feed (dilute) compartment and a concentrate (brine) compartment formed by an anion exchange membrane and a cation exchange membrane placed between two electrodes. In almost all practical electrodialysis processes, multiple electrodialysis cells are arranged into a configuration called an electrodialysis stack, with alternating anion and cation exchange membranes forming the multiple electrodialysis cells.

When referring to “water extraction” it should be understood to refer to a process where the material is mixed with an aqueous phase to create two different phases—dissolved phase and the undissolved phase (solids). When writing aqueous phase, it should be understood to refer to different PH conditions from lower PH of 3 and up to higher PH's of 10. The PH changing is obtained by the addition of acids and/or bases.

When referring to “IOX-exchange resins” it should be understood to refer to a reversible chemical reaction where dissolved ions are removed from solution and replaced with other ions of the same or similar electrical charge. The resin itself is composed of organic polymers that form a network of hydrocarbons. Throughout the polymer matrix are ion exchange sites, where so-called “functional groups” of either positively-charged ions (cations) or negatively-charged ions (anions) are affixed to the polymer network. These functional groups readily attract ions of an opposing charge.

When referring to “reaction with at least one trace element chelating agent” it should be understood to refer to a reaction using Chelating agents that are chemical compounds whose structures permit the attachment of their one, two or more donor atoms (or sites) to the same trace element ion simultaneously and produce a chelate. In some embodiments said at least one chelating agent is selected from ethylenediaminetetraacetic acid (EDTA), citric acid, and so forth. The chelation agents are bonded with the elements and then being removed using filtration process.

When referring to “membrane filtration” it should be understood to refer to a process that serves as a barrier to separate between different components based on their size differences. There are several technologies such as: micro filtration, nano filtration & Ultra filtration. By using such system, the solution is being transfer through a specific membrane. Components that are larger than the membrane (e.g. protein, fat, etc.) will stay in the inner side while smaller and/or fully dissolved components will pass the membrane. It is obtained by creating two streams, one enriched in proteins, fat, etc. and the second with minerals & trace elements, including Mg and Mn.

When referring to “air classification” it should be understood to refer to a process that can separate portions based on differences in their size and density. When using such system, the raw material is first being milled, then it transports to a cyclone where it separates into two main streams—first with high bulk density and the second with low bulk density. One stream will be obtained with high level of proteins and the second one with lower protein level.

The invention further provides a composition comprising at least one plant-based food component or ingredient having trace element content that is reduced than, as compared with, its content in the corresponding natural occurring plant-based food component or ingredient; wherein said composition is at least one of (i) a composition for the whole balance nutrition of a subject; (ii) a functional food formula, (iii) a complete nutrition, (iv) a complementary nutrition. In some embodiments the composition is non-dairy.

In some embodiments of a composition of the invention, said at least one plant-based component having reduced trace element content is a nut. In some embodiments of a composition of the invention, said at least one plant-based component having reduced trace element content is a grain. In other embodiments of a composition of the invention, said composition comprises at least one nut and at least one grain. In some embodiments said plant-based component is also treated to increase the level of protein and/or to reduce the starch/carbohydrate content. In some embodiments said at least one plant-based component is pre-treated to reduce the level of phytic acid.

In some embodiments of a composition of the invention, said composition is a non-dairy composition. In other embodiments, said composition is a non-soy composition. In other embodiments, said composition is a dairy composition.

When referring to “pre-treatment for the reduction of the level of phytic acid” it should be understood to refer to a treatment of the nut or plant-based component of the composition prior to its addition to the composition of the invention, to lower the levels (amount) of phytic acid in said nut or plant-based. Said pre-treatment of the nut or plant-based component is performed by at least one of the following: treatment of nut or plant-based component with phytase enzyme, soaking of said nut or plant-based component in water, heating of nut or plant-based component, pealing of nut or plant-based, steaming of said nut or plant-based, blanching and roasting and any combinations thereof.

Under some embodiments, said reduction or lowering of phytic acid levels is for the removal of substantially all phytic acid from the nut or plant-based component of a composition of the invention (i.e. said composition comprising no more than 0.001-0.5% wt of phytic acid).

In some embodiments, the ratio between nut and said at least one plant-based component in said composition is from about 10:90 to about 90:10.

When referring to “pre-treatment to reduce the trace elements” and/or “for the increase of the level of protein and/or to reduce the starch/carbohydrate content” of the at least one plant-based component, it should be understood to relate to at least one of, but not limited to (i) electrodialysis; (ii) water extraction; (iii) IOX-exchange resins; (iv) reaction with a trace element chelating agent; (v) membrane filtration (vi) air classification.

In some embodiments, said at least one nut is almond. When referring to almond, it should be understood to encompass any type of almond tree shelled drupe (Prunus dulcis, syn. Prunus amygdalus Batsch., Amygdalus communis L., Amygdalus dulcis Mill), in any type of form (peeled from seedcoat, unpeeled, grounded, powdered, milled and so forth). The almond provides the lipid component of the composition (including, among others the essential linolenic and alpha linolenic acids). In some embodiments, said at least one nut component is pre-treated to reduce trace elements. In other embodiments, said at least one grain component is pre-treated to reduce trace elements.

In some embodiments, the at least one nut is present in an amount of at least 10% by weight from the total weight of the composition.

In some embodiments, said at least one plant-based component is present in an amount of at least 5% by weight from the total weight of the composition.

In some embodiments, said composition is in the form of a dry composition. In other embodiments, said composition is in the form of a water-soluble dry powder. In further embodiments, said composition further comprises liquid (in some embodiments said liquid is water).

In some embodiments, said composition further comprises at least one additive selected from vitamins, minerals, trace elements, carbohydrates, lipids, amino acids, proteins and any combinations thereof.

In some embodiments, said composition further comprises at least one additive selected from nucleotides, poly-unsaturated fatty acids, fluoride, choline, a probiotic agent, prebiotic agent, and any combinations thereof.

In some embodiments, said composition further comprises at least one additive selected from a flavoring agent, an oil protective colloid, a plasticizer, an antioxidant, an emulsifier, a thickener, an acidity regulator, a packaging gas and any combinations thereof.

In some embodiments, said subject is an infant and/or toddler. In other embodiments, said subject is a child. In other embodiments, said subject is an adolescent. In other embodiments, said subject is an adult.

The invention further provides a composition comprising at least one plant-based component having reduce the level of trace elements, as defined herein above and below. The invention further provides a composition comprising at least one nut having reduced trace element content, as defined herein above and below. The invention further provides a composition comprising at least one grain having reduced trace element content, as defined herein above and below.

In some embodiments said composition is at least one of (i) a composition for the whole balance nutrition of a subject; (ii) a functional food formula, (iii) a complete nutrition, (iv) a complementary nutrition. In some embodiments the composition is a non-dairy composition. In some embodiments the composition is a dairy composition. In some embodiments the composition is non-soy composition.

The invention further provides a composition comprising at least one nut lipid component and/or at least one non-dairy component comprising all essential amino acids, wherein said at least one nut component or at least one non-dairy component contains reduced levels of at least one trace element.

The invention further provides a composition comprising at least one nut protein component and/or at least one non-dairy component comprising all essential amino acids, wherein said at least one nut component or at least one non-dairy component contains reduced levels of at least one trace elements.

In some embodiments a composition of the invention is at least one of (i) a composition for the whole balance nutrition of a subject; (ii) a functional food formula, (iii) a complete nutrition, (iv) a complementary nutrition. In some embodiments the composition is non-dairy. In other embodiments, said composition is a non-soy composition. In other embodiments, said composition is a dairy composition.

In some embodiments, said nut component contains reduced levels of at least one trace element. In some embodiments, said at least one non-dairy component contains reduced levels of at least one trace element.

In some embodiments said at least one plant-based component further contains increased levels of protein and/or to reduced starch/carbohydrate, as compared with said levels in the natural occurring at least one plant-based component. In some embodiments said at least one plant-based component further contains reduced levels of phytic acid, as compared with said levels in the natural occurring at least one plant-based component.

In some embodiments said at least one non-dairy component further contains increased levels of protein and/or to reduce the starch/carbohydrate content, as compared with said levels in the natural occurring at least one non-dairy component. In some embodiments said at least one non-dairy component contains reduced levels of phytic acid, as compared with said levels in the natural occurring at least one non-dairy component.

When referring to “at least one nut-based lipid component” it should be understood to encompass any lipid (for example triglycerides) extracted from at least one of nut, such as almond, brazil nut, candlenut, cashew, chestnut, filbert, hazelnut, Chilean hazelnut, hickory nut, macadamia nut, pecan, Malabar chestnut, mongongo, peanut, pine nut, pistachio, walnut yeheb nut and any combination thereof.

In some embodiments said at least one nut based lipid component contains increase the level of protein and/or to reduced starch/carbohydrate as compared with said levels in the natural occurring at least one nut based lipid component. In some embodiments said at least one nut based lipid component further contains reduced levels of phytic acid, as compared with said levels in the natural occurring at least nut based lipid based component.

When referring to “at least one nut-based protein component” it should be understood to encompass any protein extracted from at least one of nut, such as almond, brazil nut, candlenut, cashew, chestnut, filbert, hazelnut, Chilean hazelnut, hickory nut, macadamia nut, pecan, Malabar chestnut, mongongo, peanut, pine nut, pistachio, walnut yeheb nut and any combination thereof.

In some embodiments said at least one nut based protein component contains increased level of protein and/or to reduced levels of starch/carbohydrate, as compared with said levels in the natural occurring at least one nut based protein component. In some embodiments said at least one nut based protein component contains reduced level of phytic acid, as compared with said levels in the natural occurring at least one nut based protein component.

When referring to “a non-dairy component or ingredient” it should be understood to encompass any type of food component that does not include dairy or parts thereof. In some embodiments said non-dairy component is a plant-based component originating from, extracted from, based on, prepared from, a plant (other than a nut) naturally occurring in nature, either non-processed or processed (pealed, roasted, cooked, boiled, hydrolyzed, and so forth and any combination thereof) and in any form (grinded, shredded, powdered, chopped, mashed, non-treated and any combination thereof).

In some embodiments said non-dairy component is selected from grain, pseudo-grain, pulses, legumes, oilseeds, cereals, fruit, vegetables, and any combinations thereof. In some embodiments said non-dairy component is a legume. In some embodiments said legume is selected from alfalfa, clover, beans, peas, chickpeas, lentils, lupins, mesquite, carob, soybeans, peanuts, and tamarind and any combinations thereof. In some embodiments said non-dairy component is a grain. In some embodiments, said grain is selected from finger millet, fonio, maize (corn), millet, barley, rye grains, rice, oats, rye, teff, wheat, wild rice, and any combinations thereof.

In some embodiments, said non-dairy component is a pseudo-cereal grain. In some embodiments said pseudo-cereal grain is selected from buckwheat, amaranth, chia, quinoa and any combinations thereof.

In some embodiments, said non-dairy component is a pulse. In some embodiments, said pulse is selected from lentil, pea, chickpeas, common beans, common peas (garden peas), fava beans, lentils, lima beans, lupins, mung beans, soybeans and any combinations thereof.

In some embodiments, said non-dairy component is an oilseed. In some embodiments said oilseed is selected from rapeseed, black mustard, rapeseed (including canola), sunflower seeds, safflower, flax seed, hemp seed and any combinations thereof.

The term “non-dairy composition” refers to a composition of the invention which does not come from or includes or comprises any component that is from a dairy producing animal source, however comprises all essential amino acids needed for the nutrition of an infant, a toddler, an adult or an elderly person.

The term “non-soy composition” refers to a composition of the invention which does not come from or includes or comprises any component that is from a soy source, however comprises nutrients needed for the nutrition of an infant, a toddler, an adult or an elderly person.

When referring to “essential amino acids” (or indispensable amino acids) it should be understood to encompass the amino acids that cannot be synthesized de novo by humans, and therefore must be supplied in the diet. In the context of the present application the list of essential amino acids includes histidine, isoleucine, leucine, lysine, methionine, phenylalanine, threonine, tryptophan and valine.

In some embodiments, the ratio between said at least one nut component and said at least one non-dairy component is from about 10:90 to about 90:10. In some embodiments, said at least one nut component is present in an amount of at least 10% by weight from the total weight of the composition. In some embodiments, said at least one non-dairy component is present in an amount of at least 5% by weight from the total weight of the composition.

In some embodiments, said composition is in the form of a dry composition. In some embodiments, said composition is in the form of a water-soluble dry powder. In some embodiments, said composition further comprises water.

In some embodiments, said at least one nut component is selected from almond, brazil nut, candlenut, cashew, chestnut, filbert, hazelnut, Chilean hazelnut, hickory nut, macadamia nut, pecan, Malabar chestnut, mongongo, peanut, pine nut, pistachio, walnut yeheb nut and any combination thereof. In some embodiments, said at least one nut component is almond.

In some embodiments, at least one non-dairy component is a type of grain selected from buckwheat, barley, rice, maize, corn, millet, oats, rye, pea, chickpea, lentils, quinoa, teff, chia, bean, fava bean, sunflower, safflower, flax, rapeseed, wheat, sorghum, millet, oats, triticale, fonio, mung bean, pumpkin, amaranth and any combinations thereof. In some embodiments, at least one non-dairy component is type of pseudocereal grain selected from buckwheat, amaranth or quinoa. In some embodiments, said at least one type of non-dairy component is buckwheat. In some embodiments, said at least one type of non-dairy component is a whole grain.

In some embodiments, a composition of the invention further comprises at least one additive selected from vitamins, minerals, trace elements, carbohydrates, lipids, proteins and any combinations thereof.

In some embodiments, a composition of the invention further comprises at least one additive selected from nucleotides, poly-unsaturated fatty acids, fluoride, choline, a probiotic agent, prebiotic agent, and any combinations thereof.

In some embodiments, a composition of the invention further comprises at least one additive selected from a flavoring agent, an oil protective colloid, a plasticizer, an antioxidant, an emulsifier, a thickener, an acidity regulator, a packaging gas and any combinations thereof.

### DETAILED DESCRIPTION OF THE PRESENT INVENTION

Manganese is an essential dietary mineral for mammals, involved in amino acid, lipid and carbohydrate metabolism, thus a mandatory component of the infant formula with a minimum level. The recommended minimum level of Mn set by all regulatory authorities is of 1 μg/100 kcal (1 μg/100 kcal˜5 μg/100 gr˜7.5 μg/L) is in the order of human milk concentrations.

Though there are very few data available on Mn bioavailability in infants, its absorption rates are higher in neonates, 16-37%, compared to roughly 3% in adults. Infants and especially neonates are further susceptible to Mn toxicity due to transiently diminished biliary excretion, which is the major route of Mn excretion in humans. Mn intake and retention in children fed with infant formula are much higher than in children fed with breast milk or in adults. Soy and rice have natively high levels of Mn thus infant formulas based on soy or rice will result in higher Mn levels compared to cow milk-based formulas as reflected in recent publications, the Manganese levels in human milk are around 3-10 mcg/L, in cow milk based infant formula 30-50 mcg/L and in Soy based infant formula 200-300 mcg/L.

The European directive, the Codex Alimentarius and the ESPGHAN define also an upper limit for the Mn in infant formula based on serious concerns that have recently been raised about relatively high Mn exposures and possible associated adverse effects on child neurodevelopment. Children exposed to higher levels of Mn compared to other children have been found to have impaired cognitive development lower IQ or intelligence scores, impaired memory function, lower academic skills or achievement, impaired executive function, lower visual-spatial ability, impaired motor function, impaired olfactory function, atypical brain structure or function, and relatively high Mn exposures are suspected of increasing the risk of attention deficits, hyperactivity, or attention deficit hyperactivity disorder (ADHD), and other behavior and attention problems (Frisbie et al., PloS One 2019). The Codex and the European directive set a maximum level of 100 mcg/100 kcal (680 mcg/L) and the ESPGHAN max recommendation is 50 mcg/100 kcal (340 mcg/L). The ESPGHAN recommends avoiding higher manganese contents, since due to immature manganese excretion in infants they may cause accumulation in tissues including brain and might induce potential adverse effects.

Magnesium (Mg) is an essential mineral in the body, impacting the synthesis of biomacromolecules, bone matrix development, energy production, as well as heart, nerve, and muscle function. In food derived from plant and animal sources, Mg is mostly bound or chelated, e.g. to phytic acid, phosphates, chlorophylls or it is included in biological apatite's (skeleton).

The bioavailability of dietary magnesium is high. The concentration in human milk appears to be regulated within narrow limits, 31.4 to 35.7 mg/L (Atkinson et al., 1995) or 17-28 mg/d (Lönnerdal, 1997). Cows' milk may contain 120 to 130 mg/L (18-19 mg/100 kcal) (Atkinson et al., 1995; Greer, 1989; Lönnerdal, 1995). Formulae have been reported to contain 40-70 mg/L (6-12 mg/100 kcal) (LSRO, 1998).

Similar to Manganese, the Mg is a mandatory component of the infant formula with a minimum level. The recommended minimum level of Mg set by all regulatory authorities is of 5 mg/100 kcal (˜25 mg/100 gr˜37.5 mg/L) is in the order of human milk concentrations. The Codex, the ESPGHAN and the European directive set a maximum level of 15 mg/100 kcal (˜75 mg/100 gr˜112.5 mg/L).

### Example Number 1: Trace Elements Reduction

Materials and Suppliers: Buckwheat flour: Ziegler, batch number—B2011327001. Citric acid: Parchem, Batch number: AA-20030381-G.

Solution preparation: 15 gr of citric acid were mixed with 3000 g of water at ambient conditions to a complete dissolution to a final concentration of 0.5% (w/w).

First extraction: 200 g of buckwheat flour were mixed with 1000 g of citric acid solution (ratio of 1:5—solids to citric acid solution) and was mixed at room temperature (about 21 degrees Celsius) for 60 minutes. pH measured after 60 minutes-4.42. After 60 min the solids (product) were separated from the filtrate (by-product) using a centrifugal force for 3 minutes at 3000 RPM. Weight of wet solids—390 g, dry matter—44.54%. Weight of by-product—753 g. The by-product was discarded, 169 g from the wet solids continued to a second extraction and the rest (193 g) to oven drying for 15 h at 60 degrees Celsius.

Second extraction: The wet solids (169 g) from the first extraction stage were mixed with 500 g of fresh citric acid solution (ratio of 1:2.5 solids to citric acid solution) and were mixed at room temperature (about 21 degrees Celsius) for 15 minutes. pH measured after 15 minutes—3.83. After 15 min the solids (product) were separated from the filtrate (by-product) using a centrifugal force for 3 minutes at 3000 RPM. Weight of wet solids—161 g, dry matter—44.41%. Weight of by-product—269 g. The by-product was discarded, and 161 g of the wet solids obtained were transferred to oven drying. Total powder from first extraction—76.9 g. Total powder from second extraction—70.5 g.

TABLE 1
Trace Elements Reduction Results of Example 1

| | Protein | Mg | Mn | Cu |
|---|---|---|---|---|
| Component | g/100 g | ppm | ppm | ppm |
| Buckwheat flour | 13.1 | 1900 | 11.1 | 4.56 |
| (raw material) | | | | |
| First extraction | 13 | 638 | 5 | 3.24 |
| | | 66.42 | 55 | 29 |
| Second extraction | 13.1 | 230 | 2.21 | 3.18 |
| % reduction | | 87.89 | 80.09 | 30 |

### Example 2: Hydrolyzation Process

Materials and Suppliers: Buckwheat flour: Ziegler, batch number: B2011327001. Enzyme: alpha-amylase-BAN 480 L.

Solution Preparation: In a reactor of 1 L, 200 g of buckwheat flour were mixed with 700 gr of water. 0.25 g of alpha-amylase was added. The solution was heated to 80 degrees Celsius and mixed for 105 min. The viscosity was measured every 15 min. After 105 min the solution was transferred to a spray dryer to obtain dry free flowing powder.

### Example 3: Trace Element Reduction, Hydrolyzation and Drying on a Large-Scale

Materials and Suppliers: Buckwheat flour: Ziegler, lot number: B2013082001. Citric acid: Parchem, Batch number: AA-20030381-G. Enzyme: alpha-amylase-BAN 480 L, Batch: ADN04525. pH adjustment with NaOH (1M).

First extraction: 10 kg of citric acid were mixed with 2000 kg of water (concentration of 0.5%). 200 kg of buckwheat flour were mixed with 1000 kg of citric acid solution (ratio of 1:5—solids to citric acid solution) and were mixed at room temperature (about 22 degrees Celsius) for 60 minutes. pH measured after 60 minutes—3.8.

After 60 min solids (product) were separated from the filter (by-product) using a centrifugal force (Decanter Z4D4). Weight of the wet solids—344 kg, dry matter—47.98%. Weight of the by-product—838 kg, dry matter—1.69%. The by-product was discarded and the 344 kg of wet solids from the first extraction moved on to a second extraction.

Second extraction: The wet solids (344 kg) from the first extraction were mixed with 500 kg of fresh citric acid solution (ratio of 1:2.5—initial flour weight to citric acid solution) and were mixed at room temperature (about 21 degrees Celsius) for 15 minutes. pH (measured after 15 minutes)=3.0. After 15 min solids (product) were separated from the filtrate (by-product) using a centrifugal force (Decanter Z4D4). Weight of wet solids— 300 kg, dry matter—49.25%. Weight of by-product—540 kg, dry matter—0.7%. The by-product was discarded, the 300 kg of the wet solids were transferred to the hydrolyzation process.

Starch hydrolyzation: The wet solids (268 kg) from the second extraction stage were mixed with 249 kg of water (ratio of 1:2.55—dry solids to water). The pH obtained before the adjustment—3.52, after adjusting the pH by adding 1.12 kg of NaOH, the pH received was 6.2 pH. 0.3 kg alpha-amylase was added (0.15% from initial flour weight). The solution was heated to 80 degrees Celsius and was mixed for 70 min. After 70 min the solution was transferred to a spray dryer. Final dry powder—121.36 kg.

TABLE 2
Results of Reduction of Trace Elements of Example 3

| | Mg | Mn | Al | B | Ca | Cu | Fe | K | Zn | Hg |
|---|---|---|---|---|---|---|---|---|---|---|
| Component | ppm | ppm | ppm | ppm | ppm | ppm | ppm | ppm | ppm | ppm |
| Buckwheat flour | 1930 | 11.9 | <4.95 | 10.0 | 176 | 4.36 | 24.4 | 4110 | 16.1 | <0.005 |
| (raw material) | 172 | 1.9 | <2.0 | 2.3 | 74 | 2.87 | 24 | 338 | 2.09 | 0.0030 |
| Trace elements | | | | | | | | | | |
| reduced | | | | | | | | | | |
| buckwheat flour | | | | | | | | | | |
| % Reduction | 91.08 | 84.03 | N/R | 77 | 58 | 34.2 | 1.64 | 91.8 | 87 | N/R |
| compared to raw | | | | | | | | | | |
| material | | | | | | | | | | |

TABLE 3
Results of Protein and fatty Acid content of Example 3

| | Protein | Total fatty acids | 16:0 | 18:1 | 18:2 |
|---|---|---|---|---|---|
| Component | g/100 g | g/100 g | g/100 g | g/100 g | g/100 g |
| Buckwheat flour | 13.3 | 2.95 | 0.484 | 1.10 | 1.01 |
| (raw material) | | | | | |
| Trace elements reduced | 11.61 | 2.90 | 0.471 | 1.07 | 0.997 |
| buckwheat flour | | | | | |

TABLE 4
Results of Essentials Amino Acids content of Example 3

| | His | Isoleu | Leu | Lys | Meth | Phen | Threo | Val |
|---|---|---|---|---|---|---|---|---|
| Component | g/100 g | g/100 g | g/100 g | g/100 g | g/100 g | g/100 g | g/100 g | g/100 g |
| Buckwheat flour | 0.308 | 0.505 | 0.862 | 0.761 | 0.242 | 0.615 | 0.507 | 0.661 |
| (raw material) | | | | | | | | |
| Trace elements | 0.27 | 0.35 | 0.71 | 0.58 | 0.21 | 0.59 | 0.42 | 0.48 |
| reduced buckwheat | | | | | | | | |
| flour | | | | | | | | |
| % Ratio between | 1.07 | 0.85 | 1.00 | 0.93 | 1.06 | 1.17 | 1.01 | 0.88 |
| the percentage of | | | | | | | | |
| amino acid from | | | | | | | | |
| total amino acids | | | | | | | | |
| in the treated | | | | | | | | |
| buckwheat compared | | | | | | | | |
| to the raw material | | | | | | | | |

TABLE 5
Results of Conditionally Essential Amino Acids of Example 3

| | Arg | Cyst | Glut | Gly | Pro | Tyr |
|---|---|---|---|---|---|---|
| Component | g/100 g | g/100 g | g/100 g | g/100 g | g/100 g | g/100 g |
| Buckwheat flour | 1.34 | 0.33 | 2.29 | 0.766 | 0.487 | 0.402 |
| (raw material) | | | | | | |
| Trace elements | 1.10 | 0.22 | 1.89 | 0.54 | 0.46 | 0.29 |
| reduced buckwheat | | | | | | |
| flour | | | | | | |
| % Ratio between | 1.00 | 0.81 | 1.01 | 0.86 | 1.15 | 0.88 |
| the percentage of | | | | | | |
| amino acid from | | | | | | |
| total amino acids | | | | | | |
| in the treated | | | | | | |
| buckwheat compared | | | | | | |
| to the raw material | | | | | | |

TABLE 6
Results of Non-Essential Amino Acids of Example 3

| | Ala | Asp | Ser |
|---|---|---|---|
| Component | g/100 g | g/100 g | g/100 g |
| Buckwheat flour | 0.575 | 1.23 | 0.641 |
| Mn reduced buckwheat flour | 0.46 | 1.09 | 0.59 |
| % Ratio between the percentage of | 0.98 | 1.08 | 1.12 |
| amino acid from total | | | |
| amino acids in the treated buckwheat | | | |
| compared to the raw material | | | |

### Example 4: Infant Formula of the Invention (Large Scale)

Materials and Suppliers: Sunflower lecithin: Tradin organic, lot number: PUS201088-01. Almond butter: Treehouse, batch number:22226. Mn reduced buckwheat flour: Extractis, batch number: ERM0043. Vitamin premix XR72625: DSM, batch number: 7400004606. Mineral premix XR72497: DSM, batch number: 7400004608. Oil blend-Akonino XP 6399: AAK, batch number: 2624051. ARA-DSM, batch number: VY00404803. DHA-DAM, Batch number: VY00409119. Tyrosine: Prinova, batch number: 102011101. Leucine: Prinova, batch number: L2011002. Iso-leucine: Prinova, batch number: Y2010035

All ingredients (4 g of sunflower lecithin, 670 g of almond butter, 2503 g of Mn reduced buckwheat flour, 32 g of vitamin premix, 124 g of mineral premix, 620 g of oil blend—akonino, 10 g of ARA, 10 g of DHA, 9.2 g of tyrosine, 10.4 g of leucine and 6 g of iso-leucine) were mixed with 7429 g of water. The solution was transferred to a homogenizer and after homogenization to drying with a spray dryer.

TABLE 7
Results of Content of Components of Example 4

| | Protein | Mg | Mn | Al | Ba | Be | Cr | Cu |
|---|---|---|---|---|---|---|---|---|
| Component | g/100 g | ppm | ppm | ppm | ppm | ppm | ppm | ppm |
| Almond butter | 26.6 | 2850 | 20.6 | <2.0 | 1.8 | <0.050 | <0.20 | 9.1 |
| Trace elements | 11.61 | 172 | 1.9 | <2.0 | <0.50 | <0.050 | <0.34 | 2.87 |
| reduced buckwheat | | | | | | | | |
| flour | | | | | | | | |
| Final product-Infant | 12.5 | 638 | 4.98 | 1.32 | 0.577 | <0.050 | 0.36 | 5.25 |
| formula | | | | | | | | |

TABLE 7
Cont.-Results of Content of Components of Example 4

| | Ni | K | Cd | As | Pb | Zn | Hg |
|---|---|---|---|---|---|---|---|
| Component | ppm | ppm | ppm | ppm | ppm | ppm | ppm |
| Almond butter | 1.08 | 6890 | <0.10 | <2.0 | <1.0 | 28.9 | 0.0036 |
| Trace elements | 1.32 | 338 | <0.040 | <0.10 | <0.050 | 2.09 | <0.0030 |
| reduced | | | | | | | |
| buckwheat | | | | | | | |
| flour | | | | | | | |
| Final product- | 1.55 | 6540 | <0.040 | <0.10 | <0.050 | 25.8 | 0.0030 |
| Infant formula | | | | | | | |

### Example 5: Trace Elements Reduction

Materials and Suppliers: Buckwheat flour: Ziegler, batch number—B2011327001. Citric acid: Parchem, Batch number: AA-20030381-G

First Trace Elements Reduction

Solution preparation: 15 gr of citric acid were mixed with 3000 g of water at ambient conditions to a complete dissolution to a final concentration of 0.5% (w/w)

First extraction: 200 g of buckwheat flour were mixed with 1000 g of citric acid solution (ratio of 1:5—solids to citric acid solution) and was mixed at room temperature (about 21 degrees Celsius) for 60 minutes. pH measured after 60 minutes—4.12. After 60 min the solids (product) were separated from the filtrate (by-product) using a centrifugal force for 3 minutes at 3000 RPM. Weight of wet solids—402 g. Weight of by-product—759 g. The by-product was discarded, and 402 g of the wet solids continued to second extraction.

Second extraction: The wet solids (402 g) from the first extraction stage were mixed with 500 g of fresh citric acid solution (ratio of 1:2.5 solids to citric acid solution) and were mixed at room temperature (about 21 degrees Celsius) for 15 minutes. pH measured after 15 minutes—3.38. After 15 min the solids (product) were separated from the filtrate (by-product) using a centrifugal force for 3 minutes at 3000 RPM. Weight of wet solids—300 g. Weight of by-product—555 g. The by-product continued to second mineral reduction, and 300 g of the wet solids obtained were transferred to oven drying. Total powder from second extraction—151.5 g

Second Trace Elements Reduction

Solution preparation: 2.77 gr of citric acid were mixed with the filtrate (555 g) from the first mineral reduction at ambient conditions to a complete dissolution to a final concentration of 0.5% (w/w)

First extraction: 111 g of buckwheat flour were mixed with 555 g of citric acid solution (ratio of 1:5—solids to citric acid solution) and was mixed at room temperature (about 21 degrees Celsius) for 60 minutes. pH measured after 60 minutes—3.87. After 60 min the solids (product) were separated from the filtrate (by-product) using a centrifugal force for 3 minutes at 3000 RPM. Weight of wet solids—217 g. Weight of by-product—425 g. The by-product was discarded and 217 g of the wet solids continued to second extraction

Second extraction: The wet solids (217 g) from the first extraction stage were mixed with 277 g of fresh citric acid solution (ratio of 1:2.5 solids to citric acid solution) and were mixed at room temperature (about 21 degrees Celsius) for 15 minutes. pH measured after 15 minutes—3.38. After 15 min the solids (product) were separated from the filtrate (by-product) using a centrifugal force for 3 minutes at 3000 RPM. Weight of wet solids—183 g. Weight of by-product—304 g. The by-product continued to third mineral reduction, and 183 g of the wet solids obtained were transferred to oven drying. Total powder from second extraction—84.5 g.

Third Trace Elements Reduction

Solution preparation: 1.52 gr of citric acid were mixed with the filtrate (304 g) from the second mineral reduction at ambient conditions to a complete dissolution to a final concentration of 0.5% (w/w)

First extraction: 61 g of buckwheat flour were mixed with 304 g of citric acid solution (ratio of 1:5—solids to citric acid solution) and was mixed at room temperature (about 21 degrees Celsius) for 60 minutes. pH measured after 60 minutes—3.79.

After 60 min the solids (product) were separated from the filtrate (by-product) using a centrifugal force for 3 minutes at 3000 RPM. Weight of wet solids—60 g. Weight of by-product—235 g. The by-product was discarded, and 60 g of the wet solids continued to second extraction.

Second extraction: The wet solids (60 g) from the first extraction stage were mixed with 152 g of fresh citric acid solution (ratio of 1:2.5 solids to citric acid solution) and were mixed at room temperature (about 21 degrees Celsius) for 15 minutes. pH measured after 15 minutes—3.31. After 15 min the solids (product) were separated from the filtrate (by-product) using a centrifugal force for 3 minutes at 3000 RPM. Weight of wet solids—107 g. Weight of by-product—159 g. The by-product was discarded, and 107 g of the wet solids obtained were transferred to oven drying. Total powder from second extraction—46.5 g.

TABLE 8
Results of Trace elements Reduction of Example 5

| | Protein | Mg | Mn | Cu | Fe |
|---|---|---|---|---|---|
| Component | g/100 g | ppm | ppm | ppm | ppm |
| Buckwheat flour | 13.25 | 1900 | 11.1 | 4.56 | 26.3 |
| Frist trace elements reduction | 11.9 | 202 | 2.14 | 3.58 | 25.8 |
| % Reduction | | 89.4 | 80.7 | 21.5 | 1.9 |
| Second trace elements reduction | 13.22 | 246 | 2.6 | 3.76 | 26.3 |
| % Reduction | | 87.0 | 76.6 | 17.5 | 0 |
| Third trace elements reduction | 13.25 | 237 | 2.48 | 3.74 | 26.2 |
| % Reduction | | 87.5 | 77.6 | 18.0 | 0.4 |

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A plant-based component having trace element content that is reduced than its content in the corresponding natural occurring plant-based component.

2. A plant-based component according to claim 1, wherein said trace element is Manganese (Mn) and/or Magnesium (Mg).

3. A plant-based component according to claim 1, wherein said trace element is selected from Arsenic (As), Cadmium (Cd), Lead (Pb), Mercury (Hg), Copper (Cu), Aluminum (Al), Manganese (Mn), Magnesium (Mg) and any combinations thereof.

4. A plant-based component according to any one of claims 1 to 3, wherein said reduction is by at least 20% than its content in the corresponding natural occurring nut.

5. A plant-based component according to claims 1 to 4, being at least one nut.

6. A plant-based component according to claim 5, wherein said at least one nut is selected from almond, brazil nut, candlenut, cashew, chestnut, filbert, hazelnut, Chilean hazelnut, hickory nut, macadamia nut, pecan, Malabar chestnut, mongongo, peanut, pine nut, pistachio, walnut yeheb nut and any combination thereof.

7. A plant-based component according to claims 1 to 4, being selected from at least one of grain, pseudo grain, nut, pulse, legume, oilseed, cereal, fruit, vegetable, and any combinations thereof.

8. A plant-based component according to claims 1 to 4, being selected from buckwheat, barley, rice, maize, corn, millet, oats, rye, pea, chickpea, lentils, quinoa, teff, chia, bean, fava bean, sunflower, safflower, flax, rapeseed, wheat, sorghum, millet, oats, triticale, fonio, mung bean, pumpkin, amaranth and any combinations thereof.

9. A plant-based component according to any one of the preceding claims, wherein Manganese (Mn) content is between 0 to 20 ppm.

10. A plant-based component according to any one of the preceding claims, wherein Manganese (Mn) content is between 0 to 10 ppm.

11. A plant-based component according to any one of the preceding claims, wherein Manganese (Mn) content is between 0 to 8 ppm.

12. A plant-based component according to any one of the preceding claims, wherein Manganese (Mn) content is between 0 to 5 ppm.

13. A plant-based component according to any one of the preceding claims, wherein Manganese (Mn) content is between 0 to 3 ppm.

14. A plant-based component according to any one of the preceding claims, wherein Magnesium (Mg) content is between 0 to 1500 ppm.

15. A plant-based component according to any one of the preceding claims, wherein Magnesium (Mg) content is between 0 to 1200 ppm.

16. A plant-based component according to any one of the preceding claims, wherein Magnesium (Mg) content is between 0 to 1000 ppm.

17. A plant-based component according to any one of the preceding claims, wherein Magnesium (Mg) content is between 0 to 500 ppm.

18. A plant-based component according to any one of the preceding claims, wherein the content of Arsenic (As) is between 0 to 1 ppm.

19. A plant-based component according to any one of the preceding claims, wherein the content of Cadmium (Cd) is between 0 to 0.05 ppm.

20. A plant-based component according to any one of the preceding claims, wherein the content of Lead (Pb) is between 0 to 0.05 ppm.

21. A plant-based component according to any one of the preceding claims, wherein the content of Mercury (Hg) is between 0 to 1 ppm.

22. A plant-based component according to any one of the preceding claims, wherein the content of Copper (Cu) is between 0 to 1 ppm.

23. A plant-based component having a protein to Mg ratio of at least 100.

24. A plant-based component having a protein to Mn ratio of at least 15,000.

25. A composition comprising at least one plant-based component having reduced trace element content, as defined in any of claims 1 to 24.

26. A composition comprising at least one nut having reduced trace element content, as defined in any one of claims 1 to 24.

27. A composition comprising at least one grain having reduced trace element content, as defined in any one of claims 1 to 24.

28. A composition according to any one of claims 25 to 27, being a non-dairy composition.

29. A composition according to any one of claims 25 to 27, being a dairy composition.

30. A composition according to any one of claims 25 to 27, being a non-soy composition.

31. A method of preparing at least one plant-based component having reduced trace element content as disclosed herein above and below comprising the steps of: (a) providing at least one plant-based ingredient; (b) exposing said at least one plant-based ingredient to at least one of: (i) electrodialysis of said trace element content of said at least one plant-based ingredient; (ii) water extraction of said trace element content of said at least one plant-based ingredient; (iii) IOX-exchange resins; (iv) chelating said trace element content with at least one trace element chelating agent to form a chelate; and filtering said chelate; (v) membrane filtration (vi) air classification; thereby forming said at least one plant-based component having reduced trace element content.

32. A method according to claim 31, comprising the steps of: (a) providing at least one plant-based ingredient; (b) reacting said at least one plant-based ingredient to at least one trace element chelating agent thereby forming a chelate of said trace element content; (c) filtering said chelate of said trace element content from said at least one plant-based ingredient; thereby forming said at least one plant-based component having reduced trace element content.

33. A composition comprising at least one nut lipid component and/or at least one non-dairy component comprising all essential amino acids, wherein said at least one nut component or at least one non-dairy component contains reduced levels of at least one trace element.

34. A composition comprising at least one nut protein component and/or at least one non-dairy component comprising all essential amino acids, wherein said at least one nut component or at least one non-dairy component contains reduced levels of at least one trace element.

35. A composition according to claim 33 or 34, wherein said nut component contains reduced levels of at least one trace element.

36. A composition according to claim 33 or 34, wherein said at least one non-dairy component contains reduced levels of at least one trace element.

37. A composition according to any one of claims 33 to 36, wherein the ratio between said at least one nut component and said at least one non-dairy component is from about 10:90 to about 90:10.

38. A composition according to any one of claims 33 to 37, wherein said at least one nut component is present in an amount of at least 10% by weight from the total weight of the composition.

39. A composition according to any one of claims 33 to 38, wherein said at least one non-dairy component is present in an amount of at least 5% by weight from the total weight of the composition.

40. A composition according to any one of claims 33 to 39, being in the form of a dry composition.

41. A composition according to any one of claims 33 to 40, being in the form of a water-soluble dry powder.

42. A composition according to any one of claims 33 to 41, further comprising water.

43. A composition according to any one of claims 33 to 42, wherein said at least one nut component is selected from almond, brazil nut, candlenut, cashew, chestnut, filbert, hazelnut, Chilean hazelnut, hickory nut, macadamia nut, pecan, Malabar chestnut, mongongo, peanut, pine nut, pistachio, walnut yeheb nut and any combination thereof.

44. A composition according to any one of claims 33 to 43, wherein said at least one nut component is almond.

45. A composition according to any one of claims 33 to 45, wherein at least one non-dairy component is a type of grain selected from buckwheat, barley, rice, maize, corn, millet, oats, rye, pea, chickpea, lentils, quinoa, teff, chia, bean, fava bean, sunflower, safflower, flax, rapeseed, wheat, sorghum, millet, oats, triticale, fonio, mung bean, pumpkin, amaranth and any combinations thereof.

46. A composition according to any one of claims 33 to 45, wherein at least one non-dairy component is type of pseudocereal grain selected from buckwheat, amaranth or quinoa.

47. A composition according to any one of claims 33 to 46, wherein said at least one type of non-dairy component is buckwheat.

48. A composition according to any one of claims 33 to 47, wherein at least one type of non-dairy component is a whole grain.

49. A composition according to any one of claims 33 to 48, further comprising at least one additive selected from vitamins, minerals, trace elements, carbohydrates, lipids, proteins, amino acids and any combinations thereof.

50. A composition according to any one of claims 33 to 49, further comprising at least one additive selected from nucleotides, poly-unsaturated fatty acids, fluoride, choline, a probiotic agent, prebiotic agent, and any combinations thereof.

51. A composition according to any one of claims 33 to 50, further comprising at least one additive selected from a flavoring agent, an oil protective colloid, a plasticizer, an antioxidant, an emulsifier, a thickener, an acidity regulator, a packaging gas and any combinations thereof.

52. A composition according to any one of claims 33 to 51, wherein said subject is an infant and/or toddler.

53. A composition according to any one of claims 33 to 51, wherein said subject is an adult.
